(19) United States
(12) Patent Application Publication
(10) Pub. No.: US 2024/0149200 A1
(43) Pub. Date: May 9, 2024

(54) PULSE FILTER WITH INTEGRAL SUPPORT

(71) Applicants: Kate Taylor, Liphook (GB); Stephen D. Hiner, Salisbury (GB); James J. Ballanger, Gosport (GB)

(72) Inventors: Kate Taylor, Liphook (GB); Stephen D. Hiner, Salisbury (GB); James J. Ballanger, Gosport (GB)

(73) Assignee: ALTAIR (UK) LTD., Hemel Hempstead (GB)

(21) Appl. No.: 18/501,499

(22) Filed: Nov. 3, 2023

Related U.S. Application Data
(63) Continuation of application No. PCT/EP2023/079095, filed on Oct. 19, 2023.
(60) Provisional application No. 63/423,280, filed on Nov. 7, 2022.

(51) Int. Cl. B01D 46/24; B01D 46/00; B01D 46/64; B01D 46/71

(52) U.S. Cl. CPC B01D 46/2414; B01D 46/0005; B01D 46/64; B01D 46/71; B01D 46/58; B01D 2265/024; B01D 2265/06; B01D 2267/30; B01D 2271/022; B01D 2275/201; B01D 2279/60

(57) ABSTRACT

A filter element includes a tube of filter media, a first end cap and a second end cap. The tube of filter media extends between a first end and a second end. The tube of filter media has a cylindrical outer periphery and defines a central cavity. The first end cap is secured to the first end of the tube of filter media. The first end cap includes a first aperture having a first diameter. The second end cap is secured to the second end of the tube of filter media. The second end cap includes an attachment region adjacent the second end of the filter media and a first central hub positioned radially inward of the attachment region. The first central hub defines a second aperture having a second diameter. The second diameter is smaller than the first diameter. Systems having one or more filter elements, a tube sheet, and mounting yoke are provided.

### CROSS-REFERENCE TO RELATED PATENT APPLICATIONS

This patent application is a continuation of co-pending International Application No. PCT/EP2023/079095, filed Oct. 19, 2023, and which designates the United States. The entire teachings and disclosure of International Application No. PCT/EP2023/079095 are incorporated herein by reference thereto. International Application No. PCT/EP2023/079095 claims the benefit of U.S. Provisional Patent Application No. 63/423,280, filed Nov. 7, 2022. The entire teachings and disclosures of U.S. Provisional Patent Application No. 63/423,280 are incorporated herein by reference thereto.

### FIELD OF THE INVENTION

This invention generally relates to filter elements for filtering air and particularly to filter elements for use with gas turbine filtration systems for filtering air.

### BACKGROUND OF THE INVENTION

Systems such as gas turbine engines have filtration systems in the form of filtration houses that have a large array of filter elements mounted to a tube sheet by a corresponding array of mounting yokes. The filter elements may be of the ‘self-cleaning’ type—i.e., it may be periodically cleaned in situ by a pulse of compressed air from the downstream (clean) side which briefly reverses the flow through the pulse filter. A large array of pulse filters in a filter house will typically have hundreds of filter elements, which require replacement on a regular basis.

The traditional geometry of a filter element for such application is to have a cone element downstream from a cylindrical element. As such, the cone element is located axially between the tube sheet and the cylindrical element. However, it is also known to have a reverse geometry, that is, to reverse the position of the cone and cylindrical elements, with the cone element being upstream of the cylindrical element, such as shown in US Pat. Publ. No. 2015/0082758. To accommodate the reverse geometry, the diameter of the cylindrical element is increased to match the diameter of the larger diameter end of the cone element. This reverse geometry can provide more filtration area in the same physical space and improve the flow distribution along the length of the filter element, resulting in lower initial pressure loss for a given flowrate and improved filter life.

The mounting yoke to which these pulse filters may be mounted is typically in the form of a tripod that includes three legs fixed to the tube sheet or a housing wall. The mounting yoke and cone filter element are sized so that the weight of the latter is supported by the former until the cylindrical element is installed and both elements are secured with a nut or other securing device at the upstream end of the pulse filter.

When the configuration is reversed, with the cone element upstream of the cylindrical element, the larger diameter cylindrical element must be installed on the mounting yoke first. Due to the constant diameter of the cylindrical element, the end of the cylindrical element farthest from the tube sheet may not be well supported on a tripod-shaped mounting yoke with straight legs. Thus, while the reverse geometry results in increased performance, it also potentially leads to increased time and cost to the operator for filter installation. Furthermore, any sealing gasket on the downstream end of the filter element may not seat correctly against the tube sheet in the filter house as it is often canted relative to the sealing surface of the tube sheet when the conical filter element is installed and the fastener securing the conical filter element against the cylindrical filter element, leading to air bypass.

Known prior art includes US Pat. Publ. 2015/0082758, relating to a similar pulse filter design, and U.S. Pat. No. 8,888,884, relating to an adapter for use between the end of a filter element and a filter housing.

Other known prior art includes US Pat. Publ. 2004/0103626, U.S. Pat. No. 7,585,343, US Pat. Publ. 2008/0229927, U.S. Pat. No. 8,715,384, US Pat. Publ. 2008/0092501, U.S. Pat. Nos. 8,673,040, 8,721,756, and international patent application publication WO 2010 144012.

The invention provides improvements over the current state of the art as it relates to filter elements and particularly filter element assemblies incorporating a conical filter element stacked in axial relation to a cylindrical filter element within a filter house filtration system.

### BRIEF SUMMARY OF THE INVENTION

Examples include new and improved filter elements, filter element assemblies and filter systems. In particular, examples include new and improved filter elements, filter element assemblies and filter systems that include integrated structure in one or more filter elements for locating the filter element relative to a mounting yoke of a filter system for mounting one or more filter elements relative to a tube sheet.

In an example, a filter element including a tube of filter media, a first end cap and a second end cap is provided. The tube of filter media extends between a first end and a second end. The tube of filter media has a cylindrical outer periphery and defines a central cavity. The first end cap is secured to the first end of the tube of filter media. The first end cap includes a first aperture having a first diameter. The second end cap is secured to the second end of the tube of filter media. The second end cap includes an attachment region adjacent the second end of the filter media and a first central hub positioned radially inward of the attachment region. The first central hub defines a second aperture having a second diameter. The second diameter is smaller than the first diameter.

In one example, at least one flow aperture is formed through the second end cap radially between the first central hub and the attachment region.

In one example, the first central hub is attached to the attachment region by at least one spoke extending radially between the first central hub and the attachment region.

In one example, the first central hub is attached to the attachment region by an annular region having a plurality of fluid flow perforations therethrough.

In one example, the attachment region is an annular imperforate region forming an annular well receiving the second end of the tube of filter media.

In one example, the attachment region has a radially outer annular sidewall, a radially inner annular sidewall and a bottom wall extending radially therebetween. The second end of the tube of filter media axially received between the radially inner and outer sidewalls.

In one example, the tube of filter media has an outer radius defined by the outer periphery and an inner radius defined by an inner periphery. The tube of filter media has a filter media thickness defined between the outer radius and the inner radius. The periphery of the second aperture being spaced radially inward from the inner periphery of the tube of filter media a distance being at least 50% the filter media thickness at the second end.

In one example, the second end cap includes a connection region connecting the attachment region to the first central hub.

In one example, the connection region is provided by a nozzle that extends axially towards the first end. An outlet end of the nozzle provides the second aperture. The outlet end is positioned axially between the first and second ends of the tube of filter media.

In one example, the nozzle includes a curved surface extending between the attachment region and the first central hub. The curved surface extends radially inward and axially toward the first end of the tube of filter media when moving from the attachment region to the first central hub such that the nozzle reduces in diameter when moving from the attachment region towards the first central hub.

In one example, the second end cap includes at least one flow directing vane attaching the first central hub to the attachment region.

In one example, the at least one flow directing vane is positioned radially between the attachment region and the first central hub.

In one example, a second central hub is provided. The second central hub is spaced axially from the first central hub away from the first end of the tube of filter media. The second central hub has a third central aperture having a third diameter. The third diameter is less than the first and second diameters.

In one example, the second central hub is connected to the at least one flow directing vane. The at least one flow directing vane axially connects the first central hub to the second central hub.

In one example, the tube of filter media defines a central axis extending axially between the first and second ends. The at least one flow directing vane has a first vane end proximate the attachment region and a second vane end axially spaced from the first vane end towards the first end of the tube of filter media. The first and second vane ends are angularly offset from one another about the central axis.

In one example, the at least one flow directing vane extends axially towards the first end cap. The at least one flow directing vane has a radially inner edge that tapers radially outward when moving axially towards the first end cap.

In one example, the at least one flow directing vane is a helical vane.

In one example, the at least one flow directing vane is configured to impart an angular component about a central axis of the tube of filter media to the flow of fluid within the central cavity.

In one example, the second end cap is an end pan formed from sheet metal.

In one example, the second diameter is at least 25 percent, and more preferably at least 40 percent an outer diameter of the tube of filter media.

In one example, the first central hub defines a mounting yoke locating surface. The mounting yoke locating surface faces radially inward. The mounting yoke locating surface bounds, at least in part, the second aperture.

In an example, a filter element assembly is provided that includes a first filter element as outlined above and a conical filter element. The conical filter element is in axial alignment with the first filter element, in operation. The conical filter element includes a conical section of filter media extending between a third end and a fourth end. The conical section of filter media defines a second central cavity. The second central cavity is in fluid communication with the first central cavity of the first filter element, in operation. The third end has an outer diameter that is greater than an outer diameter of the fourth end. The second end of the tube of filter media of the first filter element has an outer diameter that is substantially equal to the outer diameter of the third end of the conical section of filter media of the conical filter element.

In some examples, the outer diameter of the second end of the tube of filter media of the first filter element is plus or minus 10 percent of the outer diameter of the third end of the conical section of filter media of the conical filter element.

In one example, the conical filter element includes a third end cap secured to the third end of the conical section of filter media. The third end cap has a fourth aperture having a fourth diameter. The fourth diameter is greater than the second diameter.

In one example, the fourth diameter is substantially equal to the first diameter of the first end cap of the first filter element.

In one example, the first end cap is substantially identical to the third end cap.

In one example, the fourth diameter is substantially equal to the second diameter of the second end cap of the first filter element.

In one example, the second end cap is substantially identical to the third end cap.

In an example, a filter system is provided. The filter system includes a filter element assembly according to any outlined above, a tube sheet and a mounting yoke. The tube sheet defines a flow aperture. The mounting yoke includes a plurality of legs that taper towards one another when moving away from the tube sheet.

In one example, the plurality of legs of the mounting yoke includes a first leg and a second leg. Each leg has a first end and a second end. The first end is connected to the tube sheet in spaced relation to one another. The second end of the first leg is connected to the second end of the second leg such that the first and second legs taper towards one another when moving away from the tube sheet towards the second ends. The first central hub is sized to locate the second end cap of the first filter element relative to the first and second legs when the filter element assembly is mounted to the mounting yoke.

In one example, the conical filter element has a fourth end cap secured to the fourth end thereof, the fourth end cap having an imperforate region closing the fourth end of the conical section of filter media, the imperforate region having a mounting hole extending therethrough. A mounting shank of the mounting yoke extends through the mounting hole. A fastener attached to the mounting shank axially secures the filter element assembly to the mounting yoke and into axial abutment with the tube sheet with the first aperture of the first end cap of the filter element in fluid communication with the flow aperture of the tube sheet.

In one example, a tube sheet seal seals the first end cap of the first filter element to the tube sheet.

In one example, a filter element assembly seal sealing the first filter element to the conical filter element. The first filter element and conical filter element being separate components that are not permanently affixed to one another.

In one example, the first central hub radially engages at least one of the first and second legs of the mounting yoke. In a more particular example, the first central hub radially engages all of the legs of the mounting yoke.

In one example, the first central hub radially engages both the first and second legs.

In one example, the mounting yoke is a tripod including a third leg having first and second ends. The first end is secured to the tube sheet in spaced relation to the first ends of the first and second legs and the second end is secured to the second ends of the first and second legs. The first central hub is sized to locate the second end cap of the first filter element relative to the first, second and third legs when the filter element assembly is mounted to the mounting yoke.

In one example, the conical filter element includes a third end cap secured to the third end of the conical filter media. The third end cap has a third aperture. The third aperture of the third end cap of the conical filter element is not radially located by the mounting yoke when the filter assembly is mounted to the mounting yoke.

In one example, the conical filter element includes a third end cap secured to the third end of the conical filter media. The third end cap has a third aperture. The third aperture of the third end cap of the conical filter element is located by the mounting yoke when the filter assembly is mounted to the mounting yoke.

In one example, the third end cap of the conical filter element is substantially identical to the second end cap of the cylindrical filter element.

In an example, a method of installing a filter element assembly to a tube sheet and mounting yoke is provided. The tube sheet defines a flow aperture. The mounting yoke extends outward from the tube sheet. The mounting yoke includes a first leg and a second leg. The legs taper towards each other when moving away from the tube sheet. The method includes mounting a first filter element to the mounting yoke with a first central hub thereof being located on the mounting yoke with the first end of the first filter element axially between the tube sheet and the second end of the first filter element. After mounting the first filter element, the method includes mounting a conical filter element to the mounting yoke and axially abutting the conical filter element against the second end cap of the first filter element.

In one example, the method includes axially compressing a first seal between the first end cap of the filter element and the tube sheet. The method includes axially compressing a second seal between the second end cap of the filter element and a third end cap of the conical filter element. The method includes securing the first filter element and the conical filter element to the mounting yoke using a fastener. The fastener provides the axial compression.

In an example, a filter element for a gas turbine having a mounting yoke is provided. The filter element includes a cone element and cylindrical element each having opposing faces. An annular mid pan is located between the opposing faces of the cone element and the cylindrical element. The cone element, cylindrical element and mid pan are fixed together. The annular mid pan is supported on the mounting yoke when the filter element is assembled on the gas turbine.

In one example, the annular mid pan has an architecture having one or more apertures to allow air flow through the length of the filter element.

In one example, the annular mid pan has an aerodynamic device configured to modify the flow distribution within the filter element.

In one example, the aerodynamic device has a configuration chosen from a group consisting of one or more flow directing vanes or a nozzle.

In one example, a mounting yoke having a longitudinal axis for supporting a filter element in a gas turbine is provided. The mounting yoke includes one or more supporting structures extending along the longitudinal axis. The annular mid pan is supported by the supporting structures along the longitudinal axis. The annular mid pan is configured to receive and support the filter element. The mid pan is fixed along the longitudinal axis of the mounting yoke and supports the filter element when the filter element is assembled on the mounting yoke.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of at least a portion of a filtration system according to an example;

FIG. 2 is an exploded illustration of a portion of the filtration system illustrated in FIG. 1 illustrating a filter element assembly removed from the mounting yoke and tube sheet thereof;

FIG. 3 is a cross-sectional illustration of a filter element assembly mounted to a mounting yoke of the filtration system;

FIG. 4 is a perspective and partial assembly illustration of a filter assembly of the filtration system of FIG. 1;

FIG. 5 is a cross-sectional illustration of a filter element assembly of the filtration system;

FIG. 6 is an exploded illustration of a cylindrical filter element of the filter element assembly;

FIG. 7 is a cross-sectional illustration of a second end cap of the cylindrical filter element of FIG. 6;

FIG. 8 illustrates the cylindrical filter element mounted to the mounting yoke of the filtration system with the conical cone of the filter element assembly removed;

FIGS. 9-11 are alternative embodiments of end caps for use with cylindrical filter elements according to examples;

FIG. 12 is a partial illustration of an alternative end cap of a cylindrical filter element mounted to the mounting yoke of a filtration system wherein the end cap includes helical vanes

FIG. 13 is a cross-sectional illustration of the end cap and mounting yoke of FIG. 12;

FIG. 14 is a front view of the end cap of FIG. 12;

FIG. 15 is a rear view opposite of FIG. 14 of the end cap of FIG. 12;

FIGS. 16 and 17 are perspective illustrations of the end cap of FIG. 12;

FIG. 18 is a partial illustration of an alternative end cap of a cylindrical filter element mounted to the mounting yoke of a filtration system wherein the end cap includes a nozzle;

FIG. 19 is a cross-sectional illustration of the end cap and mounting yoke of FIG. 18;

FIGS. 20 and 21 are cross-sectional illustrations of the end cap of FIG. 18;

FIG. 22 is a partial illustration of an alternative end cap of a cylindrical filter element mounted to the mounting yoke of a filtration system wherein the end cap includes an alternative form of a nozzle;

FIG. 23 is a cross-sectional illustration of a cylindrical filter element mounted to the mounting yoke of a filtration system using the end cap of FIG. 22;

FIGS. 24 and 25 are cross-sectional illustrations of the end cap of FIG. 22; and

FIG. 26 is a perspective illustration of the end cap of FIG. 22.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

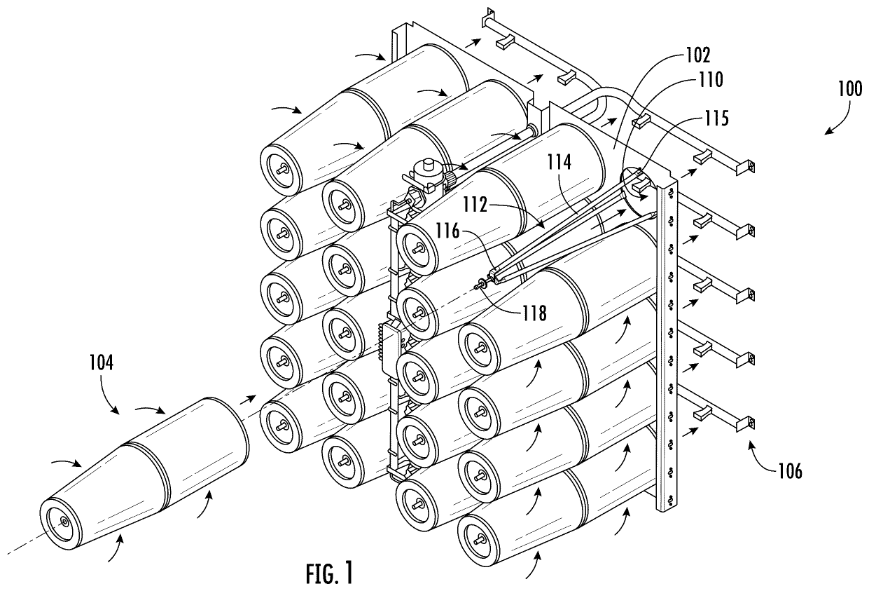

FIG. 1 illustrates a filtration system 100 and more particularly an air filtration system for filtering air for a gas turbine. While the current filtration system finds particular use in an air filtration system for a gas turbine, the filtration system 100 and components thereof may be used in other filtration systems used for filtering fluids other than air and for filtration systems use for filter fluids for other downstream systems than gas turbines.

The filtration system 100 generally includes a tube sheet 102 and a plurality of filter element assemblies 104 mounted thereto. The plurality of filter element assemblies 104 are arranged in an array. In some filtration systems 100, more than 100 filter assemblies 104 may be mounted to the tube sheet 102.

In this filtration system 100, an optional reverse pulse cleaning system 106 is provided. The reverse pulse cleaning system 106 blows air through the filter element assemblies 104 from a downstream location in an opposite direction than during normal filtering operations to remove impurities from the filter element assemblies 104 that have been separated from the fluid flowing through the filter element assemblies 104 during normal operation.

Typically, tube sheet 102 is vertically oriented and each filter element assembly 104 is mounted in a cantilevered orientation. The tube sheet 102 provides a flow aperture 110 adjacent each filter assembly 104. Fluid to be filtered will flow through each filter element assembly (radially in the illustrated example) and then through the associated flow aperture 110.

A mounting yoke 112 positioned adjacent each flow aperture 110 secures the filter element assembly 104 against the tube sheet 102 and supports the filter element assembly 104 in the cantilevered orientation.

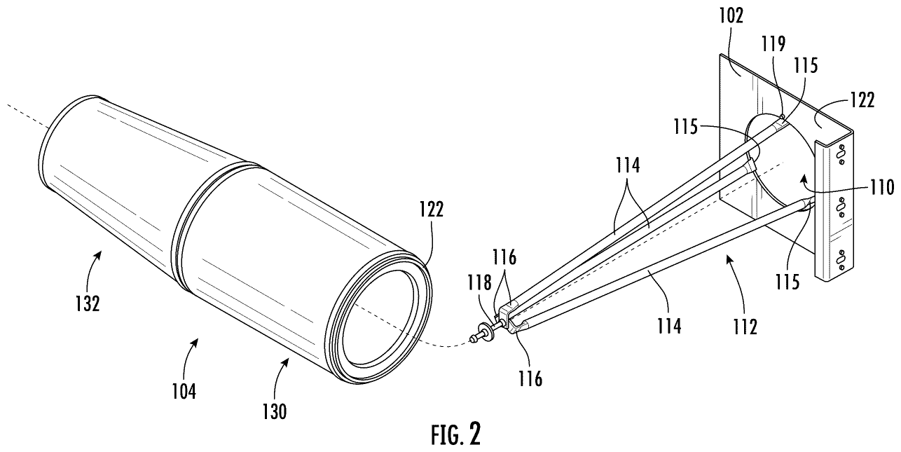

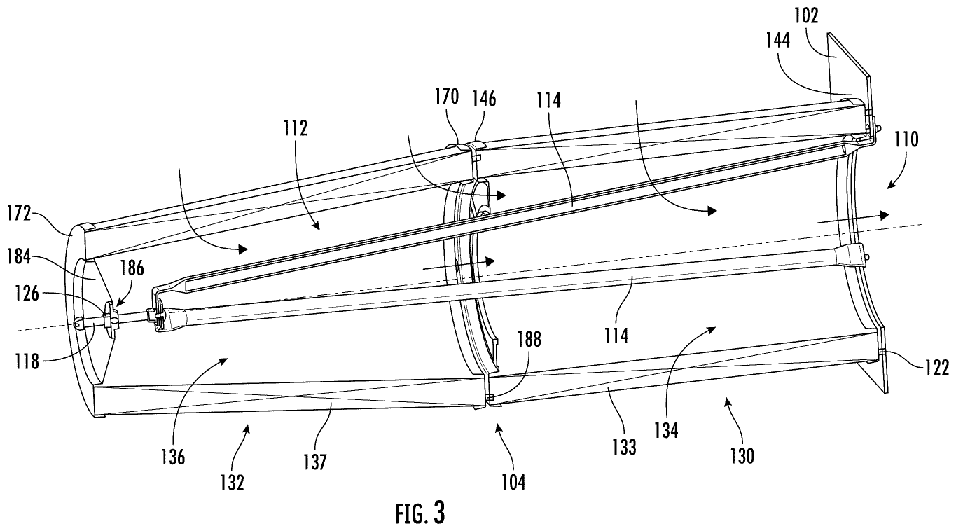

With additional reference to FIGS. 2 and 3, in this example, the mounting yoke 112 is in the form of a tripod that has three longitudinally extending legs 114. Each leg 114 extends between a first end 115 and a second end 116. The first ends 115 are operably secured to the tube sheet 102 (by screws 119 in this example). The second ends 116 are secured to one another by way of mounting stud 118. In this example, the legs 114 taper towards one another when moving axially away from the tube sheet 102 and towards the interconnected second ends 116.

A tube sheet seal 122 operably seals the filter element assembly 104 to an upstream face 124 of the tube sheet 102 to prevent fluid bypass between the filter element assembly 104 and tube sheet 102 forcing dirty fluid to flow through the filter element assembly 104 before flowing downstream.

In this example, the mounting stud 118 is a threaded post that receives a fastener 126 for securing the filter element assembly 104 to the mounting yoke 112. The fastener can axially compress the filter element assembly 104 against the tube sheet 102 and particularly tube sheet seal 122.

With reference to FIGS. 3-5, the filter element assembly 104, in this example, includes first and second filter elements in the form of cylindrical filter element 130 and conical filter element 132. Cylindrical filter element 130 includes tube of filter media 133 that defines central cavity 134 that is in operable fluid communication with central cavity 136 of a conical section of filter media 137 of conical filter element 132. In the illustrated example, filtered fluid flow 138 flows radially through the filter media 133, 137 and then axially within central cavities 134, 136 and then out through flow aperture 110 of tube sheet 102 (see FIG. 3).

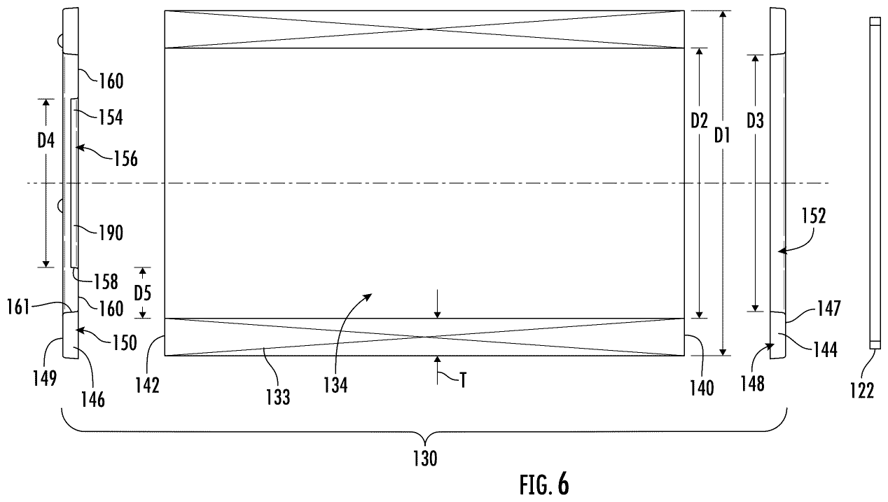

With reference to FIG. 6, tube of filter media 133 of cylindrical filter element 130 extends axially between first and second ends 140, 142. First and second end caps in the form of first and second end pans 144, 146 are operably secured to the first and second ends 140, 142 of the tube of filter media 133.

In this example, each end pan 144, 146 has an attachment region 147, 149 illustrated in the form of a bottom annular wall portion that defines in part annular well 148, 150 that receives a corresponding end 140, 142 of the tube of filter media 133. An adhesive such as plastisol or urethane may be used to secure the end pans 144, 146 to the tube of filter media 133. The annular wells 148, 150 have axially extending annular sidewalls and a radially connecting bottom wall extending radially between the inner and outer annular sidewalls.

The first end pan 144 defines a first aperture 152 that provides an exit aperture for the filter element assembly 104 through which filter air exits the filter element assembly and through flow aperture 110 of the tube sheet. In this example, the first aperture 152 is provided by a radially inner most portion of annular well 148, e.g. the radially inner axially extending annular sidewall.

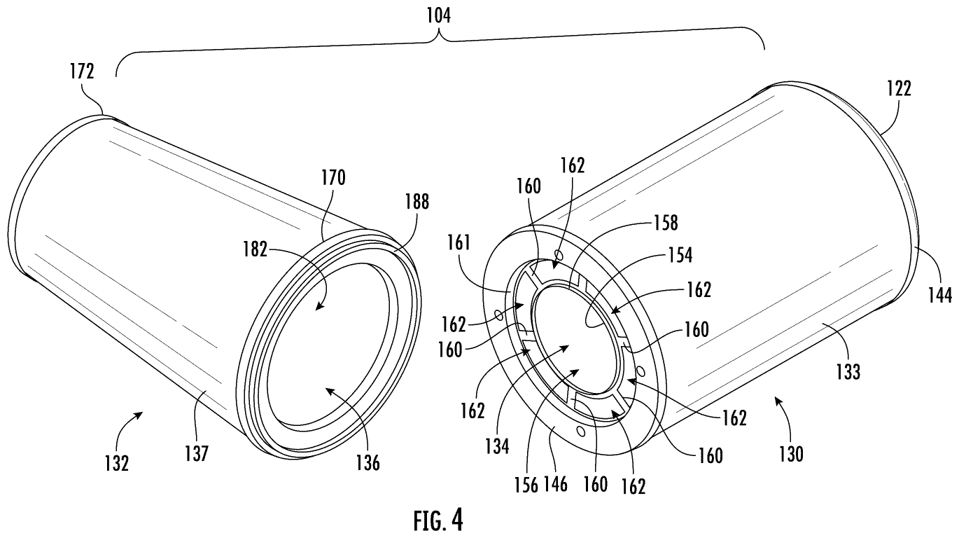

With reference to FIGS. 4-7, the second end pan 146 includes a first central hub 154 that defines a second aperture 156 through which filtered fluid that has passed through filter media 137 enters central cavity 134 before exiting the filter element assembly 104.

In this example, the first central hub 154 is provided by an axially extending sidewall 158 which is operably connected to the attachment region 149 of the second end pan 146, i.e. the second annular well 150. In this example, a plurality of spokes 160 extend radially between the radially inner most annular side wall 161 and the first central hub 154. Intermediary flow passages 162 are formed between the spokes 160. The spokes 160 thus provide a connection portion extending between the first central hub 154 and the attachment region of the second end cap 146.

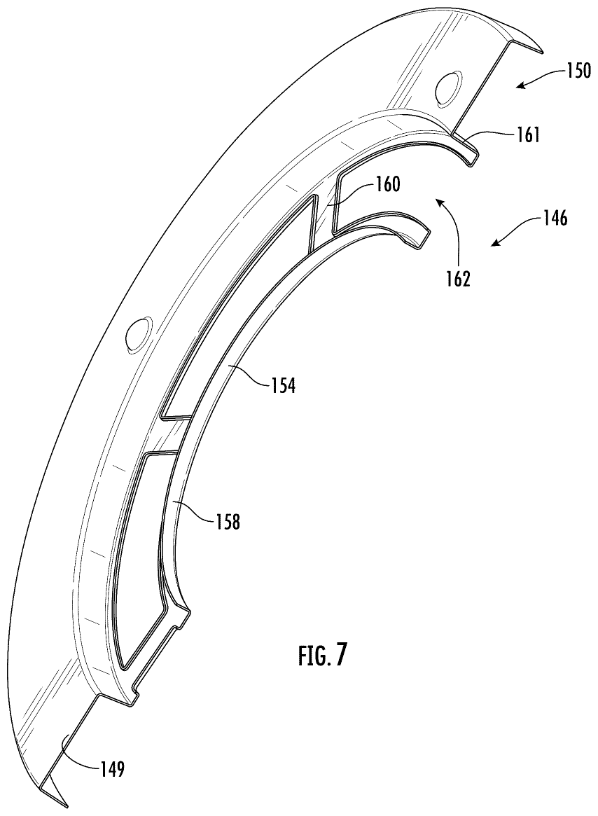

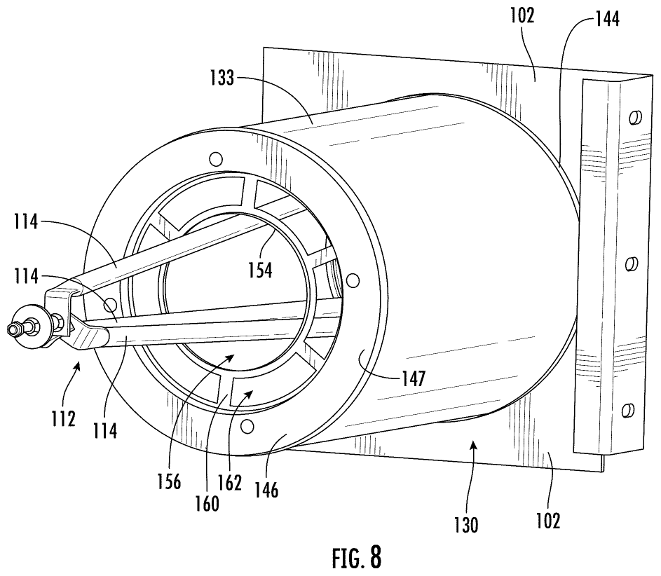

With reference to FIG. 8, the first central hub 154 is used to locate the second end of the cylindrical filter element 130 when mounting to the mounting yoke 112. More particularly and with additional reference to FIG. 6, the tube of filter media 133 filter element has substantially constant inner and outer diameters D1 and D2 along its entire axial length. Further, the first aperture 152 has a diameter D3 that is sized to allow to receive the mounting yoke 112 therethrough such that the cylindrical filter element 130 can be sealed against the tube sheet 102. Further, the diameter D3 is preferably sized such that the first end pan 144 is closely sized to a hypothetical circular periphery defined by the legs 114 of the mounting yoke 112 so as to properly align the first end pan 144 with the tube sheet 102 during assembly.

However, because the mounting yoke 112 is typically in the form of the tripod or at least in the form of a tapering support structure that defines a hypothetical circular periphery that reduces in diameter when moving axially away from the tube sheet 102, the second end pan 146 incorporates the first central hub 154 for locating the second end of the conical filter element 130 during installation. In this example, the second aperture 156 provided by central hub 154 has a diameter D4 that is smaller than diameter D3. Again, this smaller diameter D4 allows the first central hub 154 to locate the second end of the cylindrical filter element 130 when the cylindrical filter element has been mounted to mounting yok 112 but the conical filter element 132 has not yet been installed and particularly prior to fastener 118 being installed. The inclusion of first central hub 154 prevents the second end of the conical filter element 130 pivoting and tipping under gravity towards the legs 114 of the mounting yoke 112 due to the reduced periphery defined by their tapered configuration.

FIG. 8 illustrates the first central hub 154 locating relative to the legs 114 of mounting yoke 112 prior to conical filter element 132 being installed but with the cylindrical filter element 130 abutted against tube sheet 102.

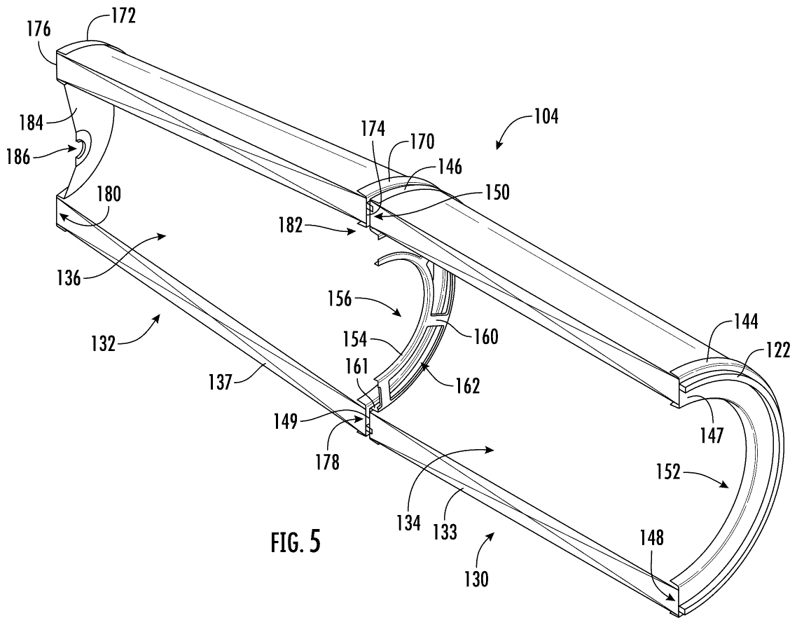

With reference to FIGS. 3 and 5, the conical filter element 132 includes first and second end pans 170, 172 attached to opposed first and second ends 174, 176 of the conical section of filter media 137. The first and second end pans 170, 172 include annular wells 178, 180 that receive ends 174, 176, respectively. The first end pan 170 defines aperture 182 that fluidly communicates central cavity 136 with central cavity 134 via aperture 156.

The second end pan 172 has a generally imperforate region 184 that spans the open second end 176 of the conical section of filter media 137. The imperforate region 184 includes a central mounting aperture 186 that receives mounting stud 118 of mounting yoke 112.

In some preferred, but optional, embodiments, the first end pan 170 of the conical filter element 132 is identical to first end pan 144 of the cylindrical filter element 130.

In other examples, the first end pan 170 is substantially identical or similar to second end pan 146 of the cylindrical filter element 130. In this arrangement, the first end pan 170 would then have a central hub similar to central hub 154 that would assist in locating that end of the conical filter element 132 during mounting.

A filter assembly seal 188 is provided between the second end pan 146 of the cylindrical filter element 130 and the first end pan 170 of the conical filter element 132. When the filter assembly 104 is mounted to the mounting yoke 112, compression of the filter element assembly 104 by fastener 126 also compresses filter assembly seal 188 between the cylindrical and conical filter elements 130, 132 forming a seal between the two filter elements 130, 132.

In preferred embodiments, the distance D5 between the inner periphery of the tube of filter media 133 and the radially inward facing locating surface 190 of the first central hub 154 is at least 50% of the radial thickness T of the tube of filter media (e.g. (diameter D1−D2)/2). In the illustrated embodiment, distance D5 is approximately 90% or more of the radial thickness T.

In one embodiment, the distance D5 between the inner periphery of the tube of filter media 133 and the radially inward facing locating surface 190 of the first central hub 154 is no more than 25% of the inner diameter D2 of the tube of filter media 133 (i.e no more than 50% of the inner radius of the tube of filter media 133).

If this is applied to a conical filter element, these dimensions are taken at the axial location where the central hub is located relative to the axial length of the filter media of the conical filter element.

In some examples, the first and second end pans 144, 146 are formed from stamped metal such as stamped sheet metal. However, other embodiments could incorporate other materials such as molded plastic. Further, in other examples, the end caps need not include wells and the end caps could be secured to the filter media in other ways such as by way of embedding the ends of the sections of filter media into the attachment regions of the end caps. In some examples, the end caps could be formed in place rather than preformed and then subsequently secured to the sections of filter media.

The inclusion of openings 162 in the second end pan 146 reduces flow restriction between the conical filter element 132 and the cylindrical filter element 130.

FIGS. 9-11 illustrate additional embodiments of second end pans 246, 346, 446. While no filter media is illustrated, a tube of filter media similar to tube of filter media 133 and a first end pan similar to first end pan 144 can be provided in combination with second end pans 246, 346, 446 to form corresponding cylindrical filter elements.

FIG. 9 illustrates a further embodiment of a second end pan 246. The second end pan 246 is substantially similar to second end pan 146. However, rather than having spokes 160, the connecting portion that extends between first central hub 254 and attachment region 247 is provided by an annular region 261 that includes a plurality of perforations 162 that help reduce flow restriction.

FIG. 10 illustrates a further embodiment of a second end pan 346 that has a connection portion provided by annular region 361. In this embodiment, the connecting portion is entirely imperforate between first central hub 354 and attachment region 347. While this design provides more resistance, it still functions to allow for locating a cylindrical filter element on a tapered mounting yoke.

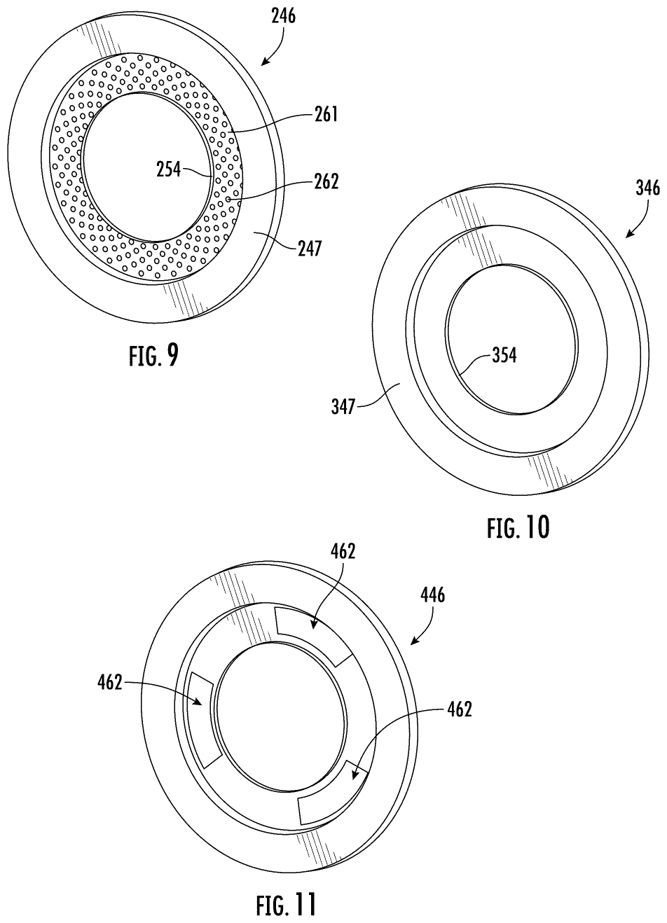

FIG. 11 illustrates a further embodiment of a second end pan 446 that includes fewer flow apertures 462 than the first embodiment of second end pan 146.

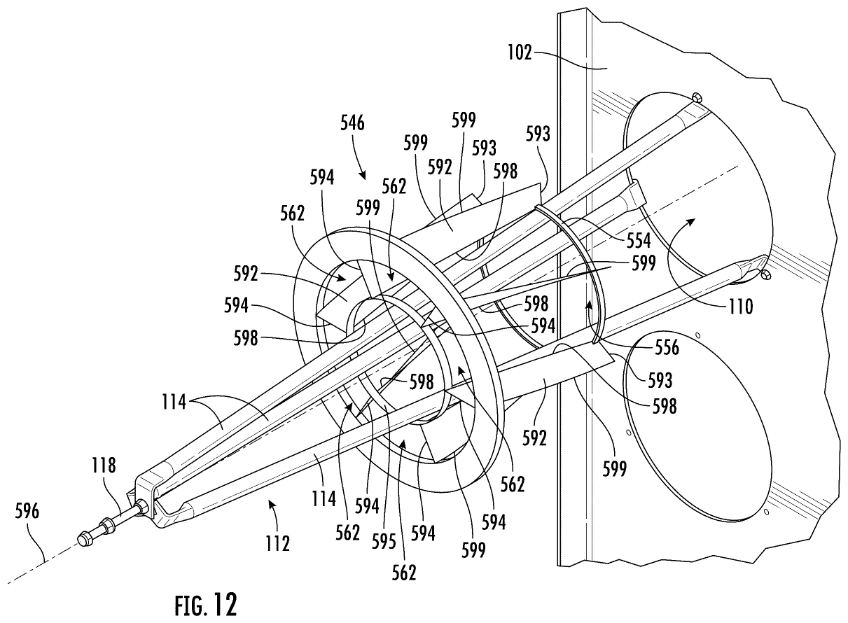

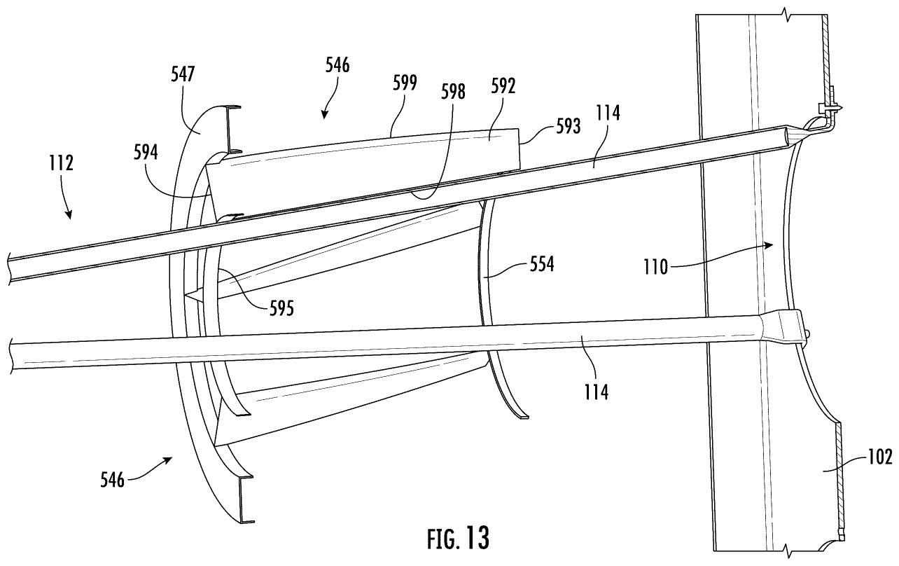

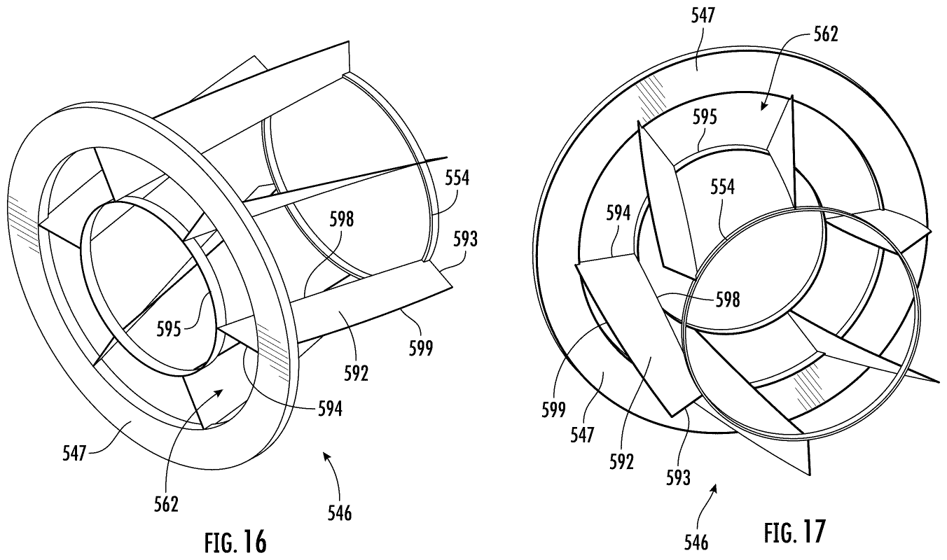

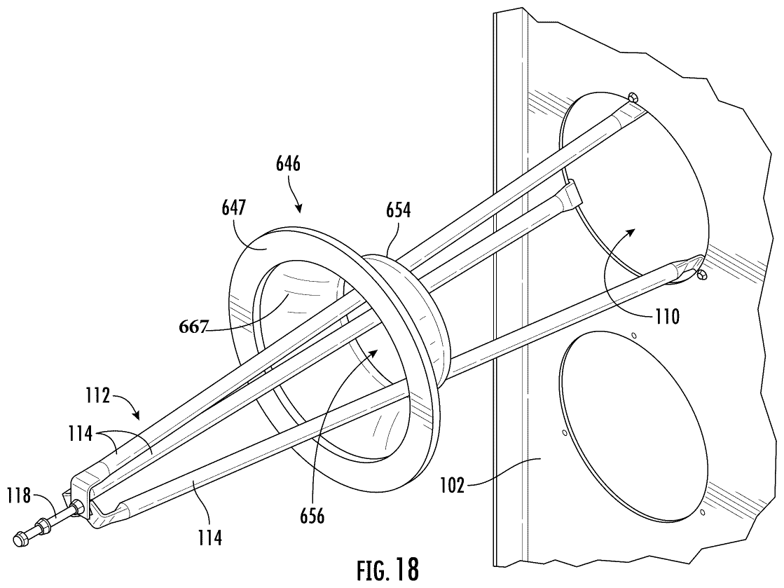

FIGS. 12-17 illustrate a further embodiment of second end pan 546 removed from the rest of the cylindrical filter element but mounted to mounting yoke 112. In this embodiment, the second end pan 546 includes an attachment region 547 similar to attachment region 147. While no filter media is illustrated, a tube of filter media similar to tube of filter media 133 and a first end pan similar to first end pan 144 can be provided in combination with second end pan 546 to form a corresponding cylindrical filter element.

The end pan 546 includes a plurality of flow directing vanes in the form of helical vanes 592 to impart swirl to flow of clean fluid within the central cavity of the filter element assembly, which results in changes to the radial pressure distribution at the filter exit plane. The choice of parameters such as pitch and the number of helical vanes 592 can reduce the overall pressure loss through the filter element and tube sheet 102. The flow directing vanes can impart an angular flow component about a central axis of the filter element assembly to the flow of clean fluid within the filter element assembly.

The helical vanes 592 extend axially from a first end 593 to a second end 594. The first end 593 is positioned proximate the first end of the tube of filter media (not shown), i.e. towards the tube sheet 102 and the second end 594 is positioned proximate the second end of the tube of filter media (not shown), i.e. towards the threaded stud 118. The second end 594 connects to the attachment region 547. The first end 593 connects to first central hub 554. Thus, the helical vanes 592 connect the attachment region 547 to the first central hub 554.

The first central hub 554 has aperture 556 that is sized and configured to locate the second end pan 546 on the hypothetical outer periphery defined by the legs 114 of the mounting yoke 112. In this example, the first central hub 554 will locate at an axial position along the mounting yoke 112 at a position axially closer to the tube sheet 102.

The first central hub 554 provides stability to the helical vanes 592 and maintains the angular spacing of the first ends 593. The first central hub is illustrated as being attached proximate radial inner edges 598 of the helical vanes 592 proximate the first ends 593.

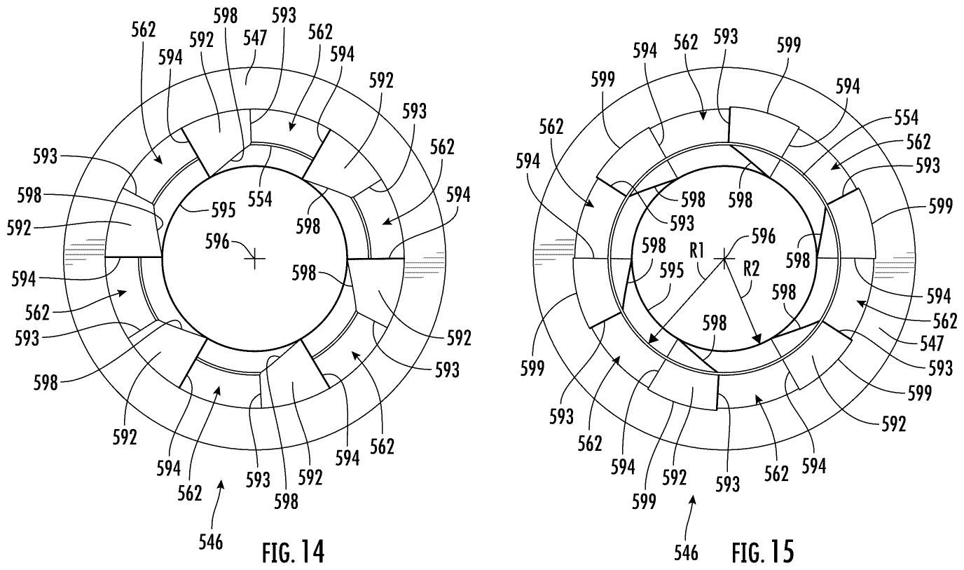

The first central hub 554 has a first radius R1 (see FIG. 15).

A second central hub 595 attaches to the radial inner edges of the helical vanes 592 proximate the second ends 594. The second central hub 595 may be configured to radially locate on the outer periphery of the legs 114. In some embodiments, the first central hub 554 is not configured to locate on the outer periphery of the legs 114 and only the second central hub 595 locates on the legs 114. In other embodiments, only the first central hub 554 radially locates on the outer periphery of legs 114.

With reference to FIG. 15, the second central hub 595 has a second inner radius R2. The second inner radius R2 is smaller than the first inner radius R1. This smaller radius R2 need only accommodate a portion of the mounting yoke 112 that defines a smaller hypothetical outer periphery.

The first end 593 of a helical vane 592 is angularly offset about central axis 596 of the second end pan 546. Further, in this example, each helical vane twists about an axis extending between the first and second ends 593, 594 when moving axially between the first and second ends 593, 594 providing the helical shape.

The helical vanes 592 are configured to spin the filtered fluid that exits the conical filter element and that flows into the corresponding cylindrical filter element to help reduce air flow pressure drop.

The radially inner edges 598 of the helical vanes 592 taper radially outward when moving from the second end 594 towards the first end 593. This prevents interference between the helical vanes 592 with the legs 114 during installation. This also corresponds to the relationship of radius R1 being greater than radius R2.

In the illustrated example, the radially outer edges 599 of the helical vanes remain at substantially a constant radial distance from central axis 596 when moving from the second end 594 to the first end 593.

In this example, the first central hub 554 that is used to locate the second end pan 546 on the mounting yoke 112 would be located axially within the central cavity of the filter media and would be positioned axially between the first and second ends of the tube of filter media (e.g. tube of filter media 133 and ends 140, 142).

Flow aperture 562 are formed between the second central hub 595 and the attachment region 547 and adjacent helical vanes 592. The helical vanes 592 act as spokes extending radially between the second central hub 595 and attachment region 547.

Helical vanes 592 as used herein may have flat faces or have curved faces.

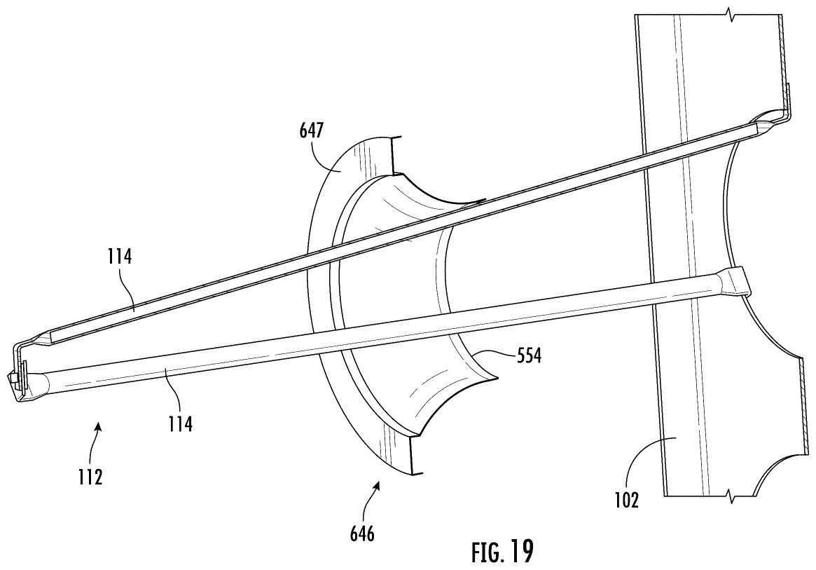

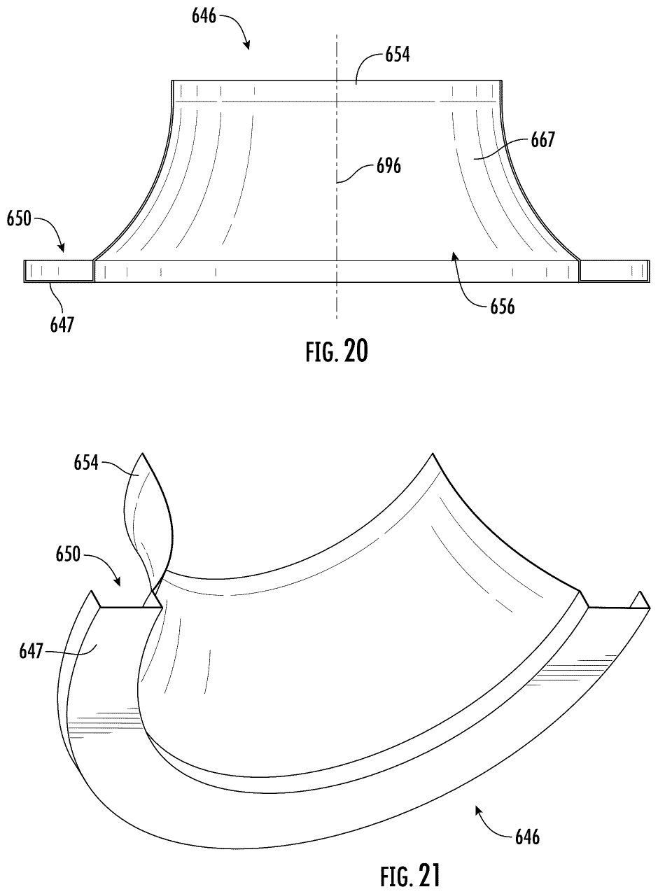

FIGS. 18-21 illustrate a further example of a second end pan 646 for use with the conical filter element. While no filter media is illustrated, a tube of filter media similar to tube of filter media 133 and a first end pan similar to first end pan 144 can be provided in combination with second end pan 646 to form a corresponding cylindrical filter element.

In this example, the connecting portion 667 extending between the attachment region 647 and the first central hub 654 forms a nozzle 656.

This configuration that includes the nozzle 656 increases the portion of flow through the upstream, conical filter element. The nozzle 656 may also reduce the pressure loss across the filter element assembly for a given flow rate of fluid flow through the filter element assembly.

The outlet end of the nozzle 656 provides a first central hub 654 that locates the cylindrical filter element on the outer periphery of the legs 114.

With reference to FIG. 20, the connecting portion 667 extends radially inward and axially towards the first end of a corresponding filter element (e.g. towards the tube sheet) when moving from the attachment region 647 towards the outlet end, e.g. first central hub 654. Further, the connecting portion 667 is a generally arcuate annular side wall. In this example, the connecting portion 667 has a cross-sectional shape in the form of a circle. In other examples, the annular side wall could have oval or elliptical cross-sectional shapes.

In this example, the connecting portion 667 is connected to a radially inner annular sidewall that forms part of well 650.

In this example, the first central hub 654 that is used to locate the second end pan 646 on the mounting yoke 112 would located axially within the central cavity of the filter media and would be positioned axially between the first and second ends of the tube of filter media (e.g. tube of filter media 133 and ends 140, 142).

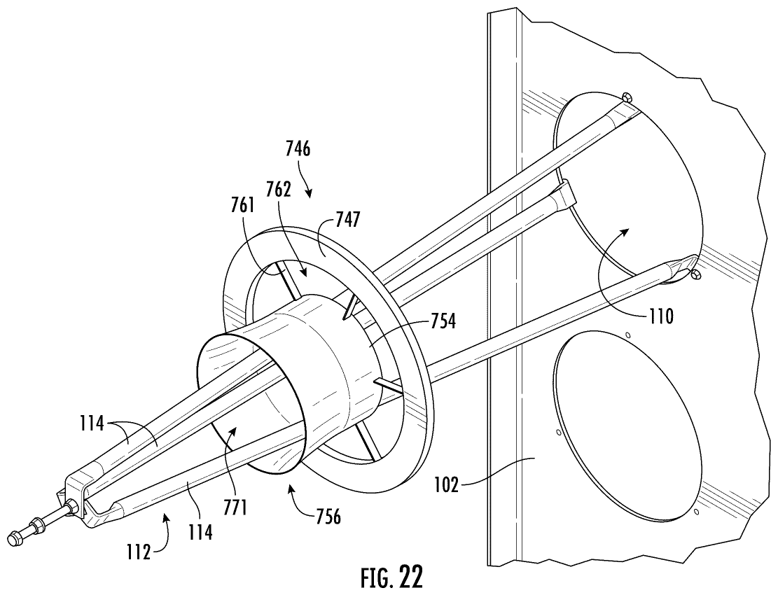

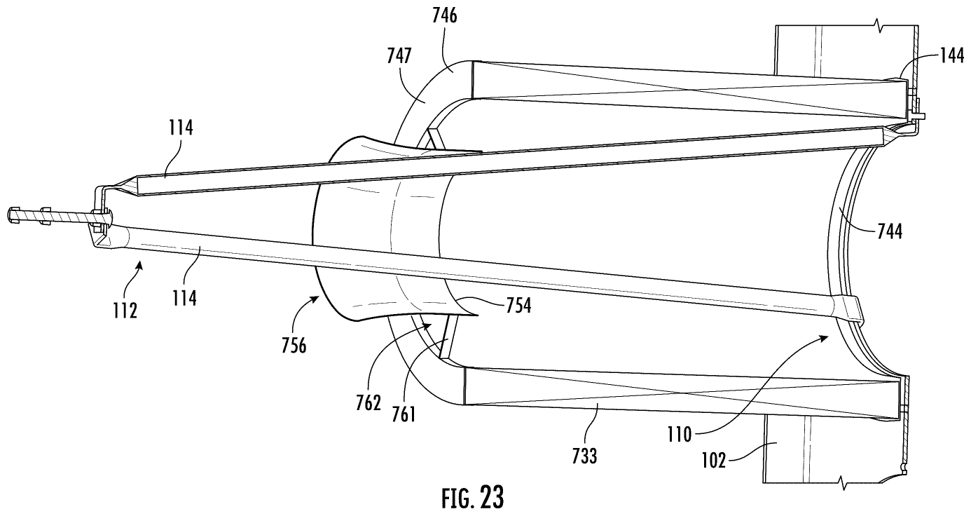

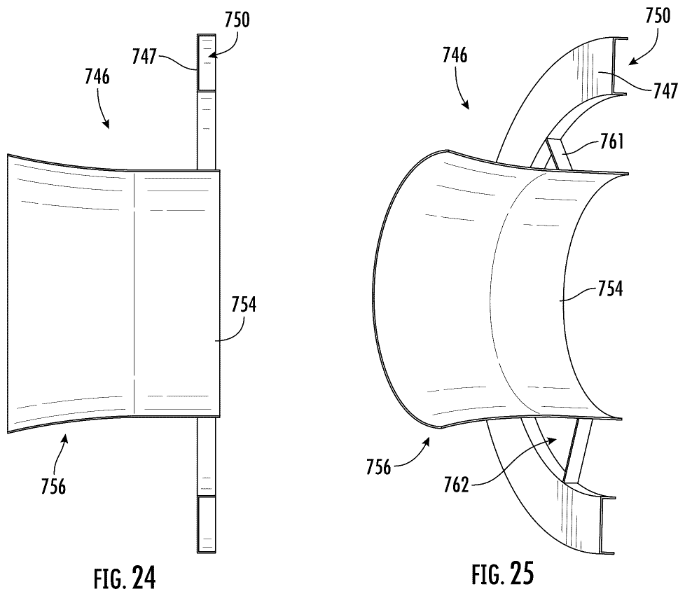

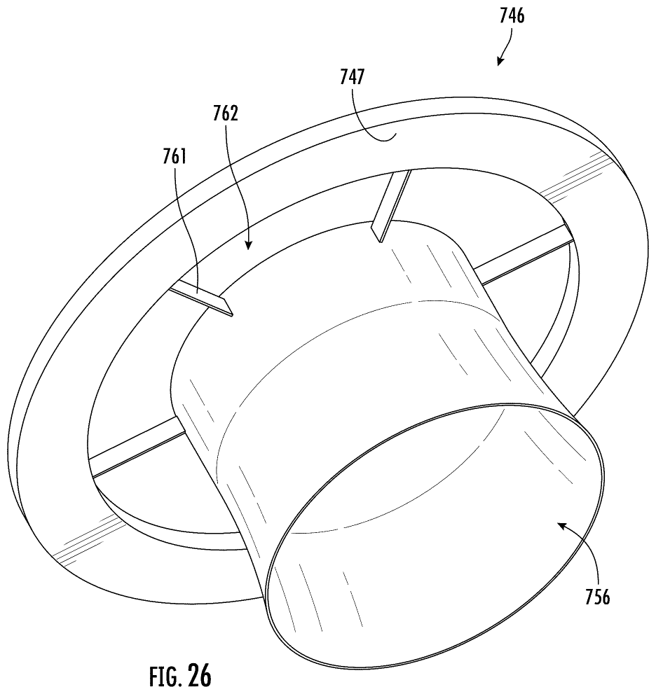

FIGS. 22-26 illustrate a further example of a second end pan 746 for use with the conical filter element 730 (see FIG. 23). Filter media 733 and first end pan 744 are illustrated in FIG. 23.

In this embodiment, an alternative form of nozzle 756 is formed upstream of first central hub 754. Again, the first central hub 754 is configured to radially locate the second end pa 746 relative to the outer periphery of legs 114.

A plurality of spokes 761 extend radially between an attachment region 747 and nozzle 756 and first central hub 754 thereof. A plurality of flow aperture 762 are provided between the spokes 761, outer periphery of nozzle 756 and the attachment region 747.

In this example, a first end 771 of the nozzle 756 is axially offset from the tube of filter media 733. The nozzle 756 would be located within the central region of a conical filter element, such as conical filter element 132 when a corresponding filter element assembly would be mounted to mounting yoke 112. In other examples (not shown), the position of the nozzle 756 may be closer to the tube sheet 102. This could require appropriate changes in the diameter of the first central hub 754 to enable it to locate on the mounting yoke 112.

The nozzle 756 generally decreases in inner diameter when moving axially from first end 771 towards the first central hub 754.

This configuration that includes the nozzle 756 increases the portion of flow through the upstream, conical filter element. The nozzle 756 may also reduce the pressure loss across the filter element assembly for a given flow rate of fluid flow through the filter element assembly.

The helical vanes 592 and nozzles 656, 756 are aerodynamic devices that may affect the amount and distribution of the pulse cleaning flow, potentially increasing the entrainment rate into the pulse jet and through the tube sheet by accelerating the flow within the filter element. The size and shape of the aerodynamic devices are configured such that they are compatible with the end pan designed to fit around the mounting yoke.

In one example, the aperture provided by the central hub that locates on the mounting yoke 112 does not carry or provide a radial seal. For example, an elastomeric or felt gasket is not adjacent the aperture through the central hub for providing a radially inward direct seal.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A filter element comprising:
a tube of filter media extending between a first end and a second end defining a central cavity, the tube of filter media having a cylindrical outer periphery;
a first end cap secured to the first end of the tube of filter media, the first end cap including a first aperture having a first diameter;
a second end cap secured to the second end of the tube of filter media, the second end cap including an attachment region adjacent the second end of the filter media and a first central hub positioned radially inward of the attachment region, the first central hub defining a second aperture having a second diameter, the second diameter being smaller than the first diameter.

2. The filter element of claim 1, wherein at least one flow aperture is formed through the second end cap radially between the first central hub and the attachment region.

3. The filter element of claim 7, wherein the connection region is at least one spoke extending radially between the first central hub and the attachment region, at least one flow aperture is formed through the connection region.

4. (canceled)

5. The filter element of claim 1, wherein the attachment region has a radially outer annular sidewall, a radially inner annular sidewall and a bottom wall extending radially therebetween, the second end of the tube of filter media axially received between the radially inner and outer sidewalls.

6. The filter element of claim 1, wherein:
the tube of filter media has an outer radius defined by the outer periphery and an inner radius defined by an inner periphery, the tube of filter media having a filter media thickness defined between the outer radius and the inner radius, the periphery of the second aperture being spaced radially inward from the inner periphery of the tube of filter media a distance being at least 50% the filter media thickness at the second end.

7. The filter element of claim 1, wherein the second end cap includes a connection region connecting the attachment region to the first central hub.

8. The filter element of claim 7, wherein the connection region is provided by a nozzle that extends axially towards the first end, an outlet end of the nozzle provides the second aperture, the outlet end being positioned axially between the first and second ends of the tube of filter media; and
wherein the nozzle includes a curved surface extending between the attachment region and the first central hub, the curved surface extending radially inward and axially toward the first end of the tube of filter media when moving from the attachment region to the first central hub such that the nozzle reduces in diameter when moving from the attachment region towards the first central hub.

9. (canceled)

10. The filter element of claim 1, wherein the second end cap includes at least one flow directing vane attaching the first central hub to the attachment region; and
wherein the at least one flow directing vane is configured to impart an angular component about a central axis of the tube of filter media to the flow of fluid within the central cavity.

11. (canceled)

12. The filter element of claim 10, further including a second central hub, the second central hub being spaced axially from the first central hub away from the first end of the tube of filter media, the second central hub having a third central aperture having a third diameter, the third diameter being less than the first and second diameters.

13. (canceled)

14. The filter element of claim 10, wherein the tube of filter media defines a central axis extending axially between the first and second ends, the at least one flow directing vane has a first vane end proximate the attachment region and a second vane end axially spaced from the first vane end towards the first end of the tube of filter media, the first and second vane ends being angularly offset from one another about the central axis.

15. The filter element of claim 10, wherein the at least one flow directing vane extends axially towards the first end cap, the at least one flow directing vane has a radially inner edge that tapers radially outward when moving axially towards the first end cap.

16-20. (canceled)

21. A filter element assembly comprising:
a first filter element according to claim 1; and
a conical filter element in axial alignment with the first filter element, the conical filter element comprising:
a conical section of filter media extending between a third end and a fourth end, the conical section of filter media defining a second central cavity, the second central cavity in fluid communication with the first central cavity of the first filter element, the third end having an outer diameter that is greater than an outer diameter of the fourth end, the second end of the tube of filter media of the first filter element having an outer diameter that is substantially equal to the outer diameter of the third end of the conical section of filter media of the conical filter element.

22. The filter element assembly of claim 21, wherein:
the conical filter element includes a third end cap secured to the third end of the conical section of filter media;
the third end cap having a fourth aperture having a fourth diameter, the fourth diameter being greater than the second diameter.

23-26. (canceled)

27. A filter system comprising:
a filter element assembly of claim 21;
a tube sheet defining a flow aperture;
a mounting yoke including a first leg and a second leg, each leg having a first end and a second end, the first end being proximate to the tube sheet and being in spaced relation to one another, the second end of the first leg being proximate to the second end of the second leg, the first and second legs tapering towards one another when moving away from the tube sheet towards the second ends;
wherein the first central hub is sized to locate the second end cap of the first filter element relative to the first and second legs when the filter element assembly is mounted to the mounting yoke.

28. The filter system of claim 27, wherein the conical filter element has a fourth end cap secured to the fourth end thereof, the fourth end cap having an imperforate region closing the fourth end of the conical section of filter media, the imperforate region having a mounting hole extending therethrough, a mounting shank of the mounting yoke extending through the mounting hole;
further comprising a fastener attached to the mounting shank axially securing the filter element assembly to the mounting yoke and into axial abutment with the tube sheet with the first aperture of the first end cap of the filter element in fluid communication with the flow aperture of the tube sheet.

29-32. (canceled)

33. The filter system of claim 27, wherein the mounting yoke is a tripod including a third leg having first and second ends, the first end being secured to the tube sheet in spaced relation to the first ends of the first and second legs and the second end being secured to the second ends of the first and second legs;
wherein the first central hub is sized to locate the second end cap of the first filter element relative to the first, second and third legs when the filter element assembly is mounted to the mounting yoke.

34-36. (canceled)

37. A method of installing a filter element assembly to a tube sheet defining a flow aperture and having a mounting yoke extending outward from the tube sheet, the mounting yoke including a first leg and a second leg, each leg having a first end proximate the tube sheet in spaced relation to one another and a second end, the second ends of the first and second legs being proximate one another such that the first and second legs taper towards each other when moving away from the tube sheet towards the second ends, the method comprising:
mounting a filter element of claim 1 to the mounting yoke with the first central hub being located on the mounting yoke with the first end of the first filter element axially between the tube sheet and the second end of the first filter element; and
after mounting the first filter element, mounting a conical filter element to the mounting yoke and axially abutting the conical filter element against the second end cap of the first filter element.

38. The method of claim 37, further comprising:
axially compressing a first seal between the first end cap of the filter element and the tube sheet; and
axially compressing a second seal between the second end cap of the filter element and a third end cap of the conical filter element.
securing the first filter element and the conical filter element to the mounting yoke using a fastener, the fastener providing the axial compression.

39. A filter element for a gas turbine having a mounting yoke, the filter element comprising:
a first and a second section;
the first section having a top end pan attachable to the mounting yoke, and the second section having a bottom end pan with an annular opening that can be located against a filter housing thereby connecting the filter element to a flow aperture;
the bottom end pan having an aerodynamic device circumscribing the annular opening;
wherein the aerodynamic device has a configuration that modifies the flow distribution within the filter element.

40. The filter element as in claim 39, wherein the aerodynamic device has a configuration chosen from a group consisting of one or more helical vanes, a nozzle, or an ejector.
